(19) United States
(12) Patent Application Publication
(10) Pub. No.: US 2012/0075549 A1
(43) Pub. Date: Mar. 29, 2012

(54) WHITE LIGHT EMITTING DIODE DEVICE, LIGHT EMITTING APPARATUS, AND LIQUID CRYSTAL DISPLAY DEVICE

(75) Inventors: Ruei-Teng Lin, Keelung City (TW); Wei-Chih Ke, Taipei County (TW); Chih-Lin Wang, Hsinchu City (TW)

(73) Assignee: AU OPTRONICS CORPORATION, Hsinchu (TW)

(21) Appl. No.: 13/198,734

(22) Filed: Aug. 5, 2011

(30) Foreign Application Priority Data
Sep. 29, 2010 (TW) 99133081

(51) Int. Cl. G02F 1/13357; F21V 9/16

(52) U.S. Cl. 349/61; 362/84

(57) ABSTRACT

A white light emitting diode (LED) device includes a blue LED light source, a sealant material, a green phosphor material, and an orange phosphor material. The sealant material covers the blue LED light source. The green phosphor material distributed in the sealant material includes (Lu_{1-x-y-a-b}YₓGd_{y})₃(Al_{1-z}Ga_{z})₅O₁₂:CeₐPr_{b}, wherein 0≦x≦1, 0≦y≦1, 0≦z≦0.1, 0≦a≦0.2, and 0≦b≦0.1. The orange phosphor material, which is also distributed in the sealant material, include the compound A, the compound B, or both. The compound A is (Sr_{1-x-y-z}CaₓBa_{y}Mg_{z})₂SiO₄:Eu_{w}, wherein 0≦x≦1, 0≦y≦1, 0≦z≦1, and 0.03≦w≦0.2. The compound B is (M1)ₓ(M2)_{y}(Si,Al)₁₂(O,N)₁₆, wherein M1 represents Li, Mg, Ca, or Y, M2 represents Ce, Pr, Eu, Tb, Yb, or Er, 0.05≦x+y≦1.5, and 0≦y≦0.7.

### CROSS-REFERENCE TO RELATED APPLICATION

This application claims the priority benefit of Taiwan application serial no. 99133081, filed Sep. 29, 2010. The entirety of the above-mentioned patent application is hereby incorporated by reference herein and made a part of this specification.

### BACKGROUND OF THE INVENTION

1. Field of the Invention

The invention relates to a white light emitting diode (LED) device, a light emitting apparatus having the white LED device, and a liquid crystal display (LCD) having the white LED device.

2. Description of Related Art

Along with the great development of semiconductor science and technology, LED has been extensively applied in display and illumination fields due to its well characteristics such as high luminance output, low power consumption, small volume occupancy, low driving voltage, and mercury-free content. In the conventional white LED application, phosphors of different emission wavelengths are used to generate the light different from the light which were emitted by the chip. The chromaticity is composed and changed by the ratio of intensity of blue light to phosphors'. Said technology one of the most prevailing white light technology.

Currently, various phosphor materials have been developed with specific wavelength in the white LED applications. Most people focus on the conversion efficiency but few mention to thermal stability and reliability. However, reliability is an important characteristic essential to the lifetime, too. Hence, when the phosphor materials with favorable thermal stability and reliability are employed in the white LED device, the lifetime of the white LED device can be extended, and the luminosity can be also enhanced.

### SUMMARY OF THE INVENTION

The invention is directed to a white LED device, a light emitting apparatus having the white LED device, and an LCD having the white LED device. Since phosphor materials applied herein are characterized by favorable thermal stability and reliability, the white LED device can have long lifetime and great performance.

The invention provides a white LED device that includes a blue LED light source, a sealant material, a green phosphor material, and an orange phosphor material. The sealant material covers the blue LED light source. The green phosphor material is distributed in the sealant material and includes (Lu_{1-x-y-a-b}YₓGd_{y})₃(Al_{1-z}Ga_{z})₅O₁₂:CeₐPr_{b}, wherein 0≦x≦1, 0≦y≦1, 0≦z≦0.1, 0≦a≦0.2, and 0≦b≦0.1. The orange phosphor material is also distributed in the sealant material and includes the compound A, the compound B, or both as below. The compound A is (Sr_{1-x-y-z}CaₓBa_{y}Mg_{z})₂SiO₄:Eu_{w}, wherein 0≦x≦1, 0≦y≦1, 0≦z≦1, and 0.03≦w≦0.2. The compound B is (M1)ₓ(M2)_{y}(Si,Al)₁₂(0,N)₁₆, wherein M1 represents Li, Mg, Ca, or Y, M2 represents Ce, Pr, Eu, Tb, Yb, or Er, 0.05≦x+y≦1.5, and 0≦y≦0.7.

The invention further provides a light emitting apparatus that includes a frame body and at least one white LED device located in the frame body. Herein, the at least one white LED device refers to the aforesaid white LED device.

The invention further provides an LCD that includes an LCD panel and a backlight module configured on a rear side of the LCD panel. The backlight module includes at least one white LED device. Herein, the at least one white LED device refers to the aforesaid white LED device.

Based on the above, the special green phosphor material and the special orange phosphor material that are applied in the white LED device of the invention have favorable thermal stability and reliability in comparison with the conventional green and orange phosphor materials. Therefore, the white LED device can have satisfactory performance and long lifetime.

In order to make above advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic cross-section view illustrating a white LED device according to an embodiment of the invention.

FIG. 2 is a curve illustrating thermal stability of various phosphor materials which are applied in a white LED device.

FIG. 3 is a curve illustrating reliability of various phosphor materials in combination which are applied in a white LED device.

FIG. 4 is a schematic view illustrating a light emitting apparatus according to an embodiment of the invention.

FIG. 5 is a schematic view illustrating an LCD according to an embodiment of the invention.

### DESCRIPTION OF EMBODIMENTS

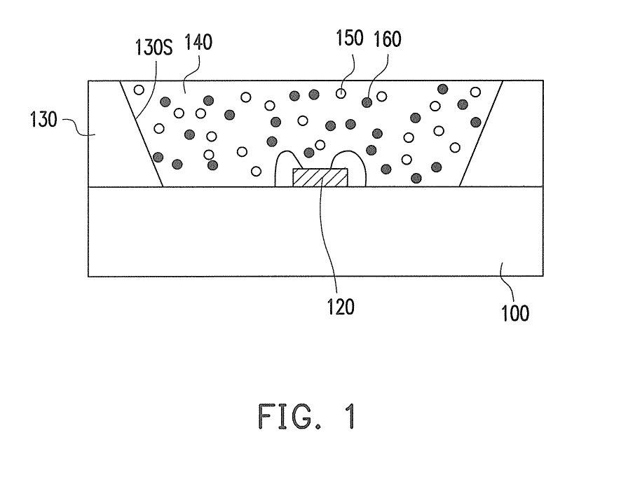

FIG. 1 is a schematic cross-section view illustrating a white LED device according to an embodiment of the invention. With reference to FIG. 1, the white LED device of this embodiment includes a blue LED light source 120, a sealant material 140, a green phosphor material 150, and an orange phosphor material 160. According to this embodiment, the white LED device further includes a carrier 100 and a molding structure 130.

The blue LED light source 120 is configured on the carrier 100. Herein, the blue LED light source 120 is, for instance, a blue LED chip, and the light emission wavelength of the blue LED light source 120 is from about 440 nm to about 460 nm. According to an embodiment of the invention, the carrier 100 is a lead-frame that includes a main body (not shown) and conductive wires (not shown) formed on the main part, for example. Note that the carrier 100 can also be any other type of known carrier. According to another embodiment of the invention, the carrier 100 can also be a circuit board or any other substrate. The blue LED light source 120 configured on the carrier 100 is electrically connected to the conductive structure in the carrier 100. In this embodiment, the blue LED light source 120 is electrically connected to the conductive structure in the carrier 100 by wire bonding. However, the invention is not limited thereto. In other embodiments of the invention, the blue LED light source 120 can also be electrically connected to the conductive structure in the carrier 100 in other manner of electrical connection, e.g., performing a soldering process.

The molding structure 130 is configured on the carrier 100 according to this embodiment. Herein, the molding structure 130 can be formed with an injection molding process. Besides, the molding structure 130 has an accommodation space 130S, and the blue LED light source 120 is configured in the accommodation space 130S of the molding structure 130. However, in another embodiment of the invention, it is not likely to form the molding structure 130. That is to say, the blue LED light source 120 is simply configured on the carrier 100.

The sealant material 140 covers the blue LED light source 120. The sealant material 140 can include silicone, epoxy, or other transparent adhesive materials.

In this embodiment, the accommodation space 130S of the molding structure 130 is filled with the sealant material 140 to cover the blue LED light source 120.

The upper surface of the sealant material 140 and the upper surface of the molding structure 130 are co-planar in this embodiment. However, the invention is not limited thereto. According to another embodiment, the upper surface of the sealant material 140 can protrude from the upper surface of the molding structure 130. Alternatively, if there is no molding structure 130 configured on the carrier 100, the sealant material 140 can be directly formed on the blue LED light source 120 with a dispensing process.

The green phosphor material 150 and the orange phosphor material 160 are distributed in the sealant material 140. In an embodiment of the invention, the green phosphor material 150 and the orange phosphor material 160 are mixed with the sealant material 140 in a liquid form, and then the accommodation space 130S of the molding structure 130 is filled with the mixture. Alternatively, the mixture is coated onto the blue LED light source 120 by the dispensing process. According to other embodiments of the invention, the phosphor materials 150 and 160 distributed in the sealant material 140 can be evenly distributed, remotely distributed away from the blue LED light source, or conformally distributed close to the surface of the blue LED light source.

In particular, the green phosphor material 150 includes (Lu_{1-x-y-a-b}YₓGd_{y})₃(Al_{1-z}Ga_{z})₅O₁₂:CeₐPr_{b}, wherein 0≦x≦1, 0≦y≦1, 0≦z≦0.1, 0≦a≦0.2, and 0≦b≦0.1. Preferably, the green phosphor material 150 includes Lu₃Al₅O₁₂:Ce³⁺. Besides, a light emission wavelength of the green phosphor material 150 is from about 525 nm to about 545 nm.

The orange phosphor material 160 can be for example compound A, compound B, combination of compound A and compound B, material comprising compound A, material comprising compound B, or material comprising compound A and compound B. Namely, the orange phosphor material 160 can include the compound A, the compound B, or both. A light emission wavelength of the orange phosphor material 160 is from about 590 nm to about 610 nm.

The compound A is (Sr_{1-x-y-z}CaₓBa_{y}Mg_{z})₂SiO₄:Eu_{w}, wherein 0≦x≦1, 0≦y≦1, 0≦z≦1, and 0.03≦w≦0.2. Preferably, the compound A is (Sr,Ca,Ba)₂SiO₄:Eu²⁺.

The compound B is (M1)ₓ(M2)_{y}(Si,Al)₁₂(O,N)₁₆, wherein M1 represents Li, Mg, Ca, or Y, M2 represents Ce, Pr, Eu, Tb, Yb, or Er, 0.05≦x+y≦1.5, and 0≦y≦0.7. Preferably, the compound B is Ca-α-SiAlON:Eu²⁺.

It should be mentioned that a ratio of the total weight of the green phosphor material 150 and the orange phosphor material 160 to the weight of the sealant material 140 is about 4% to about 30%. According to this embodiment, a weight ratio (Green/Orange, G/O) of the green phosphor material 150 to the orange phosphor material 160 in the sealant material 140 is about 1 to about 20.

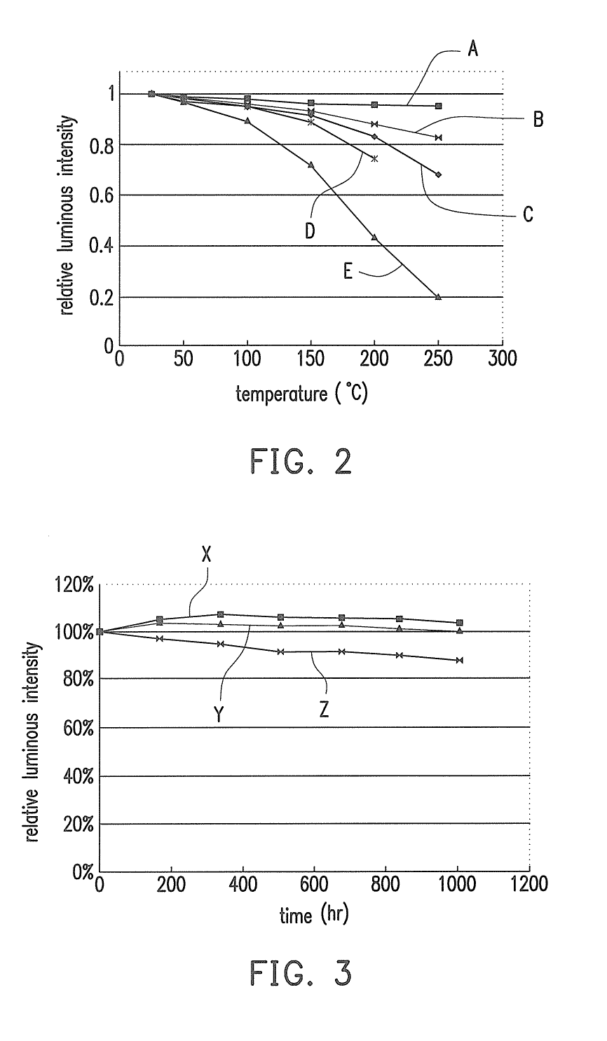

FIG. 2 is a curve illustrating thermal stability of various phosphor materials. The horizontal coordinate of FIG. 2 stands for temperature, while the vertical one stands for relative luminous intensity. Besides, in this embodiment as shown in FIG. 2, the curve A represents the correlation between the relative luminous intensity and the temperature of the green phosphor material Lu₃Al₅O₁₂:Ce³⁺; the curve B represents the correlation between the relative luminous intensity and the temperature of the orange phosphor material Ca-α-SiAlON:Eu²⁺; the curve C represents the correlation between the relative luminous intensity and the temperature of the conventional phosphor material YAG:Ce³⁺; the curve D represents the correlation between the relative luminous intensity and the temperature of the conventional phosphor material Sr₂Si₅N₈:Eu²⁺; the curve E represents the correlation between the thermal stability and the temperature of the conventional silicate phosphor material.

It can be observed from FIG. 2 that the green phosphor material Lu₃Al₅O₁₂:Ce³⁺ (curve A) and the orange phosphor material Ca-α-SiAlON:Eu²⁺ (curve B) of this embodiment have desirable thermal stability than other conventional phosphor materials (curves C to E). Therefore, when the green phosphor material Lu₃Al₅O₁₂:Ce³⁺ (curve A) and the orange phosphor material Ca-α-SiAlON:Eu²⁺ (curve B) are applied together to the blue LED light source in the white LED device, favorable thermal stability of the white LED device can be guaranteed.

FIG. 3 is a curve illustrating reliability of various phosphor materials in combination which are applied to an LED device. The horizontal coordinate of FIG. 3 stands for time, while the vertical one stands for relative luminous intensity of the LED device. The reliability test condition is to burn in the LED at 60° C. with 90% relative humidity for 1,000 hours. In this embodiment as shown in FIG. 3, the curve X represents the correlation between the relative luminous intensity and the time of the combined green phosphor material Lu₃Al₅O₁₂:Ce³⁺ and orange phosphor material Ca-α-SiAlON:Eu²⁺; the curve Y represents the correlation between the relative luminous intensity and the time of the combined green phosphor material Lu₃Al₅O₁₂:Ce³⁺ and conventional orange silicate phosphor; the curve Z represents the correlation between the relative luminous intensity and the time of the combined conventional green silicate phosphor and conventional orange silicate phosphor.

It can be observed from FIG. 3 that the combined green phosphor material Lu₃Al₅O₁₂:Ce³⁺ and orange phosphor material Ca-α-SiAlON:Eu²⁺ (curve X) of this embodiment has favorable reliability in comparison with the other two combinations (curves Y and Z).

As described above, the special green phosphor material and the special orange phosphor material are collectively applied along with the blue LED light source in the white LED device of the invention. Since the phosphor materials utilized in this embodiment have great thermal stability and reliability in comparison with the conventional phosphor material, the while LED device of this embodiment is characterized by favorable performance and long lifetime.

The white LED device depicted in FIG. 1 can be applied to various light-emitting/illumination apparatuses, backlight modules of displays, and so forth. The detailed description is given as follows.

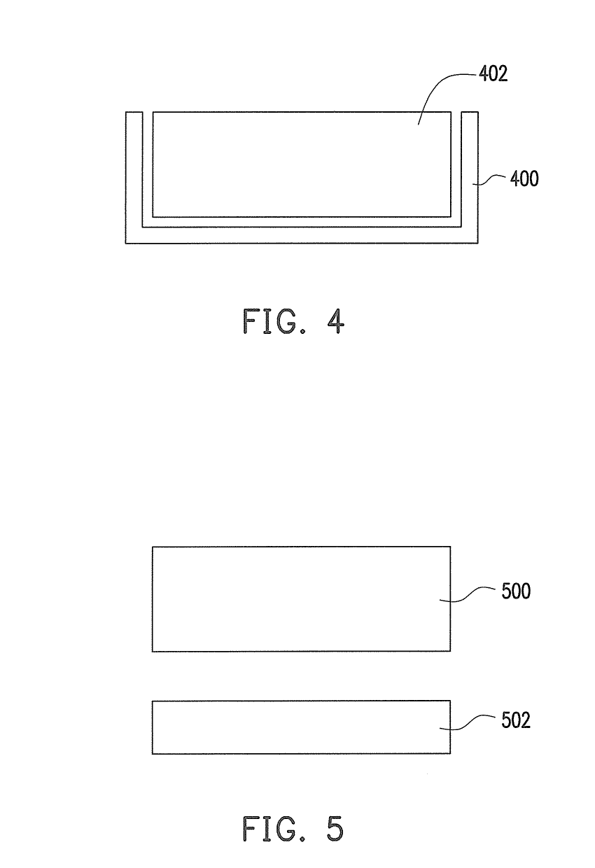

FIG. 4 is a schematic view illustrating a light emitting apparatus according to an embodiment of the invention. With reference to FIG. 4, the light emitting apparatus of this embodiment includes a frame body 400 and at least one white LED device 402 located in the frame body 400. The frame body 400 mainly serves to secure, accommodate, and protect the white LED device 402. In addition, the frame body 400 can also serve to embellish the light emitting apparatus. Here, the frame body 400 can be made of metal or plastic. The shape and the look of the frame body 400 are not limited in this invention and can be adjusted and modified based on application fields or design of the light emitting apparatus. On the other hand, the white LED device 402 can refer to the white LED device shown in FIG. 1. The white LED device 402 configured in the frame body 400 can be singular or plural. Given there are plural white LED devices 402 configured in the frame body 400, the white LED devices 402 can be arranged in arrays, in the manner of straight lines, or in the manner of curves.

FIG. 5 is a schematic view illustrating an LCD according to an embodiment of the invention. With reference to FIG. 5, the LCD of this embodiment includes an LCD panel 500 and a backlight module 502 configured on a rear side of the LCD panel 500. In particular, the backlight module 500 includes at least one white LED device, and the white LED device in the backlight module 500 can refer to the white LED device shown in FIG. 1. Besides, the backlight module 502 can be a direct-type backlight module or an edge-type backlight module, and the light source in the direct-type backlight module or the edge-type backlight module 502 is the white LED device as depicted in FIG. 1.

In light of the foregoing, the special green phosphor material and the special orange phosphor material that are applied in the white LED device of the invention have favorable thermal stability and reliability in comparison with the conventional phosphor material. Therefore, the white LED device can have satisfactory performance and long life span.

Moreover, since the white LED device of the invention is characterized by satisfactory performance and long life span, the light emitting apparatus having the white LED device or the display having the white LED device can also have satisfactory performance/display quality and long life span.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A white light emitting diode device comprising:
a blue light emitting diode light source;
a sealant material covering the blue light emitting diode light source;
a green phosphor material distributed in the sealant material and comprising:
(Lu_{1-x-y-a-b}YₓGd_{y})₃(Al_{1-z}Ga_{z})₅O₁₂:CeₐPr_{b}, wherein 0≦x≦1, 0≦y≦1, 0≦z≦0.1, 0≦a≦0.2, and 0≦b≦0.1;
an orange phosphor material distributed in the sealant material comprising compound A or compound B,
the compound A being (Sr_{1-x-y-z}CaₓBa_{y}Mg_{z})₂SiO₄:Eu_{w}, wherein 0≦x≦1, 0≦y≦1, 0≦z≦1, and 0.03≦w≦0.2,
the compound B being (M1)ₓ(M2)_{y}(Si,Al)₁₂(O,N)₁₆, wherein M1 represents Li, Mg, Ca, or Y, M2 represents Ce, Pr, Eu, Tb, Yb, or Er, 0.05≦x+y≦1.5, and 0≦y≦0.7.

2. The white light emitting diode device as claimed in claim 1, wherein a ratio of a total weight of the green phosphor material and the orange phosphor material to a weight of the sealant material is about 4% to about 30%.

3. The white light emitting diode device as claimed in claim 2, wherein a weight ratio G/O of the green phosphor material to the orange phosphor material is about 1 to about 20.

4. The white light emitting diode device as claimed in claim 1, wherein a light emission wavelength of the green phosphor material is about 525 nm to about 545 nm.

5. The white light emitting diode device as claimed in claim 1, wherein a light emission wavelength of the orange phosphor material is about 590 nm to about 610 nm.

6. The white light emitting diode device as claimed in claim 1, wherein a light emission wavelength of the blue light emitting diode light source is about 440 nm to about 460 nm.

7. The white light emitting diode device as claimed in claim 1, wherein the sealant material comprises silicone or epoxy.

8. The white light emitting diode device as claimed in claim 1, further comprising:
a carrier, the blue light emitting diode light source being configured on the carrier; and
a molding structure located on the carrier and having an accommodation space, the blue light emitting diode light source being located in the accommodation space,
wherein the accommodation space is filled with the sealant material to cover the blue light emitting diode light source.

9. The white light emitting diode device as claimed in claim 1, wherein the green phosphor material and the orange phosphor material distributed in the sealant are evenly distributed, remotely distributed away from the blue light emitting diode light source, or conformally distributed close to the surface of the blue light emitting diode light source.

10. A light emitting apparatus comprising:
a frame body;
at least one white light emitting diode device as claimed in claim 1 located in the frame body.

11. A liquid crystal display comprising:
a liquid crystal display panel; and
a backlight module configured on a rear side of the liquid crystal display panel, wherein the backlight module comprises at least one white light emitting diode device as claimed in claim 1.
